(19) United States
(12) Patent Application Publication
(10) Pub. No.: US 2012/0031005 A1
(43) Pub. Date: Feb. 9, 2012

(54) SUSPENDED PULLEY STRUCTURE FOR MOVABLE AND FOLDING DOORS

(76) Inventor: Shou-Hsing LIAO, Taichung City (TW)

(21) Appl. No.: 12/851,624

(22) Filed: Aug. 6, 2010

(51) Int. Cl. E05F 11/54

(52) U.S. Cl. 49/360

(57) ABSTRACT

The present invention is related to a suspended pulley structure for a movable and folding door which is mounted in a track on the ceiling for hanging a door leaf. The pulley structure includes a pulley set having at least four wheels which are straddled at the right and left sides of the bottom of the track and roll. The pulley set has at least four horizontal turning wheels hinged thereon and divided into two pairs at the front and rear sides respectively roll against the right and left walls of the track. Between the two pairs of the horizontal turning wheels, a vertical rolling wheel is mounted for rolling at the top of the track. Thereby, it can prevent the door leaf from swinging and/or tilting during folding or unfolding and also avoid the folded door leaves from tilting.

### FIELD OF THE INVENTION

The present invention is related to a pulley structure mounted on a suspended door used for partition, and more particularly to a pulley structure which can prevent the suspended door from swinging and tilting.

### BACKGROUND OF THE INVENTION

Please refer to FIG. 1 and FIG. 2 which are schematic views showing a conventional track-sliding type folding door. The door includes a pulley set 1, a pair of pulleys 2 hinged at the pulley set 1, and a door leaf 3 pivotally connected to the bottom of the pulley set 1, wherein the door leaf 3 can be movably rotated, and the pulleys 2 are straddled in a hollow track 4 so as to roll in a pair of grooves 4 inside the track 4. The track 4 can have plural pulley sets 1 mounted therein for hanging plural door leaves 3 pivotally connected to the pulley sets 1. The plural door leaves 3 can be unfolded and stretched out to provide a temporary partition for being used in a store or a restaurant, and also can be movably rotated and folded to one side of the track 4. Because the pulleys 2 can be rotated freely in the track 4, the door leaves 3 can be conveniently folded and unfolded to provide partition function.

However, in some places, the center of gravity of the plural door leaves 3 is fallen on the outer side of the track 4, that is the pulley set 1 is mounted at one side of the top of the door leaf 3. Then, if the pulleys 2 described above are assembled with the track 4, the track 4 restricts the pulleys 2 to roll along a straight line but cannot prevent the pulleys 2 from deviating aside while rolling. Therefore, the door leaves 3 might tilt due to its center of gravity is fallen on the outer side of the track 4, and further, when unfolding/folding the door leaves 3, the pulleys 2 not only might swing but also might tilt, and thus accordingly cause the door leaves 3 to swing and tilt.

For solving this problem, it is developed to further dispose a channel (not shown in the drawings) under the door leaves 3 for receiving another pulley set of each door leaf 3 to slide, so as to prohibit the tilt of the door leaves 3.

### SUMMARY OF THE INVENTION

The object of the present invention is to provide a suspended pulley structure for a movable and folding door which can prevent the center of gravity of the door leaf from deviating aside to cause swinging and/or tilting during folding/unfolding, and also can avoid the folding door leaves from tilting one side of the track owing to the center of gravity.

Another object of the present invention is to provide a more smooth movement while pushing and pulling the door leaf.

For achieving the object described above, the present invention provides a suspended pulley structure for a movable and folding door which is mounted in a track on the ceiling for hanging a door leaf. The pulley structure includes a pulley set with at least four wheels, wherein each two wheels respectively mounted on the front and rear sides of the pulley set are respectively straddled at the right and left sides of the bottom of the track and roll; at least four horizontal turning wheels which are divided into a front pair and a rear pair and are vertically hinged at the top of the pulley set in a manner that the two pairs of horizontal turning wheels are respectively turned against the right and left walls of the track at the same level; at least two vertical rolling wheels are transversely hinged on the right and left sides of the pulley set and roll along the top in the track; and a suspended assembly mounted at the bottom of the pulley set for pivotally hanging the door leaf.

After the pulley set is assembled with the track, because the four horizontal turning wheels respectively at the right and left sides, the two vertical rolling wheels respectively at the upper and lower sides and the four wheels of the pulley set are restricted by the track, such that the pulley set sliding along the track will not swing and tilt as folding/unfolding along the door leaf. And, it also can avoid folding plural door leaves from tilting, which is caused by the center of gravity deviated outside the track.

Furthermore, owing to the two vertical rolling wheels roll at the top in the track, and the four wheels of the pulley set roll at the bottom of the track, the top and the bottom of the pulley set can roll and slide inside the track, so as to facilitate smooth movement while pulling and pushing the door leaf.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing a conventional track-sliding type folding door;

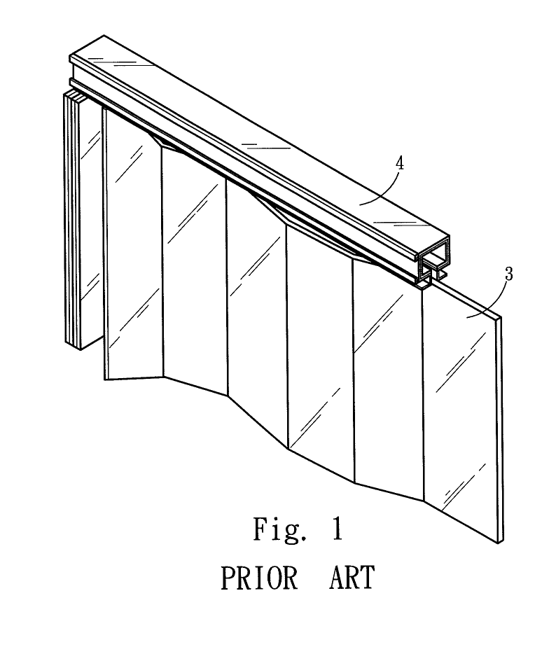

FIG. 2 is a sectional view showing the conventional track-sliding type folding door;

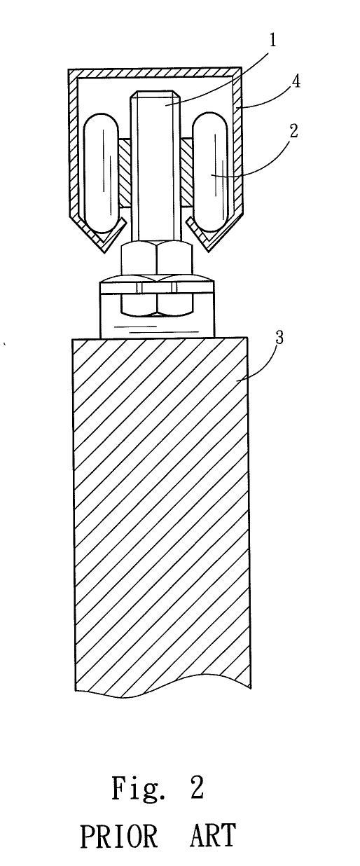

FIG. 3 is an exploded view showing an embodiment of the pulley structure of the present invention;

FIG. 4 is a sectional view showing the pulley structure of the present invention assembled with the track;

FIG. 5 is a schematic view showing an embodiment of the pulley structure mounted at the top of a door leaf and deviated aside according to the present invention;

FIG. 6 is a schematic view showing an embodiment of the pulley structure and the track as the plural door leaves are folded according to the present invention;

FIG. 7 is a schematic view showing an embodiment of the pulley structure as the plural door leaves are unfolded and stretched out in a straight line according to the present invention; and

FIG. 8 is a schematic view showing an embodiment of the pulley structure and the door leaf according to the present invention.

### DESCRIPTION OF THE PREFERRED EMBODIMENT

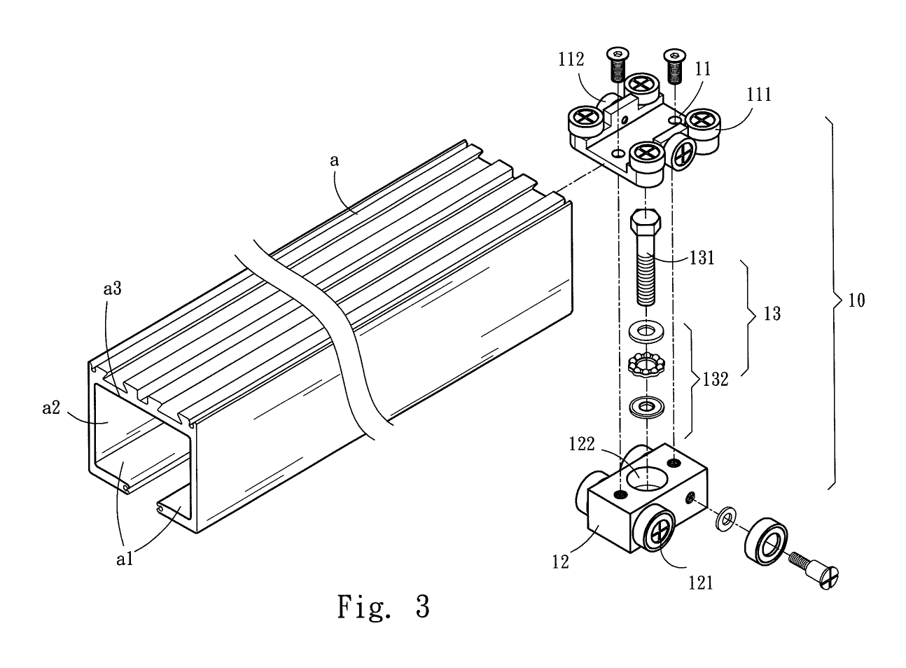

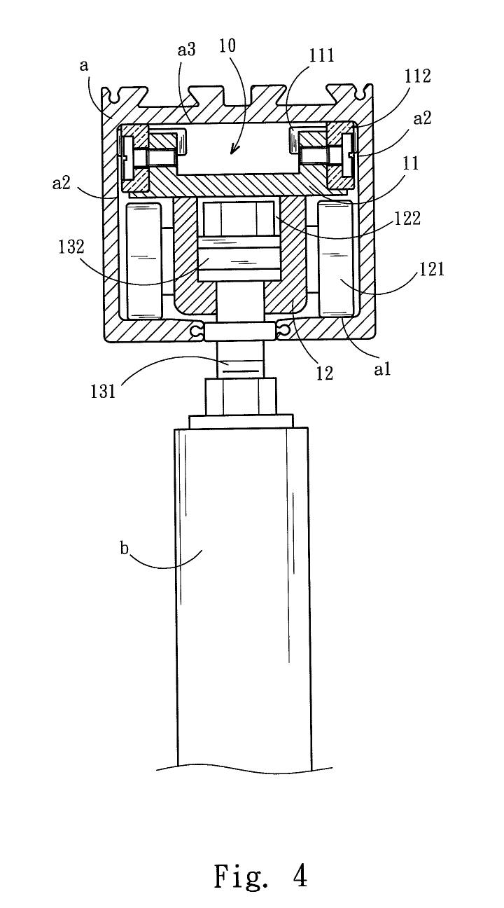

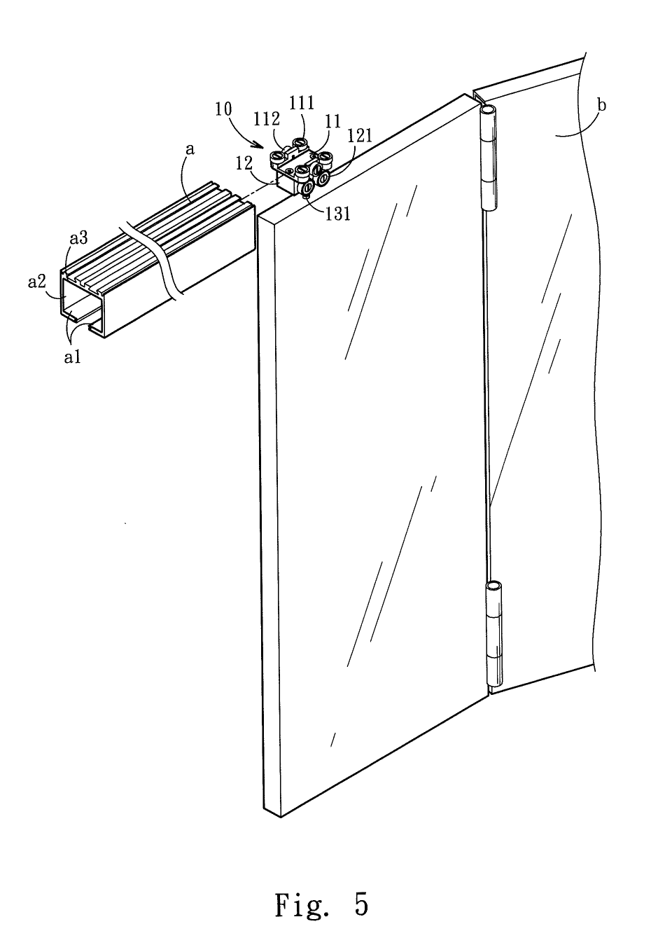

Please refer to FIG. 3 which is an exploded view showing an embodiment of a pulley structure of the present invention, FIG. 4 which is a sectional view of the pulley structure of the present invention as being assembled with the track, and FIG. 5 which is a schematic view showing an embodiment of the pulley structure mounted at the top of a door leaf and deviated aside according to the present invention. As shown, the present invention is related to a suspended pulley structure used for a movable and folding door which is mounted in a track a on the ceiling for hanging a door leaf b to move. The pulley structure includes a pulley set 10, at least four wheels 121, four horizontal turning wheels 111, at least two vertical rolling wheels 112 and a suspended assembly 13.

In this embodiment, the pulley set 10 includes an upper pulley base 11 and a lower pulley base 12 locked at the bottom of the upper pulley base 11 via at least one screw, wherein the lower pulley base 12 has at least four wheels 121, and each two wheels 121 are respectively straddled at the left and right sides of the bottom a1 of the track a and roll. And, the lower pulley base 12 also has a circular trough 122 vertically formed in the center thereof.

The four horizontal turning wheels 111, which are divided into a front pair and a rear pair, are vertically hinged at the four corners on the upper pulley base 11 in a manner that the two pairs of horizontal turning wheels 111 respectively turn against the right and left walls a2 of the track a at the same level.

The at least two vertical rolling wheels 112 are respectively hinged at the right and left sides of the upper pulley base 11 in a lateral direction. In this embodiment, each vertical rolling wheel 112 is hinged between the two pairs of the horizontal turning wheels 111, so as to roll at the top a3 of the track a.

The suspended assembly 13 which is mounted in the center of the lower pulley base 12 includes a suspended shaft (in this embodiment is a bolt 131) for vertically hanging the door leaf b and a trust ball bearing 132 sleeving on the bolt 131. The trust ball bearing 132 is installed in the trough 122 for connecting the lower pulley base 12 to the bolt 131. One end of the bolt 131 is formed in a head portion having a diameter larger than the bolt 131, and the other end is vertically and downwardly penetrates through the center of the trust ball bearing 132 and the lower pulley base 12 so as to be locked with the door leaf b. Here, the upper portion of the trough 122 is formed to provide a space for receiving the head portion.

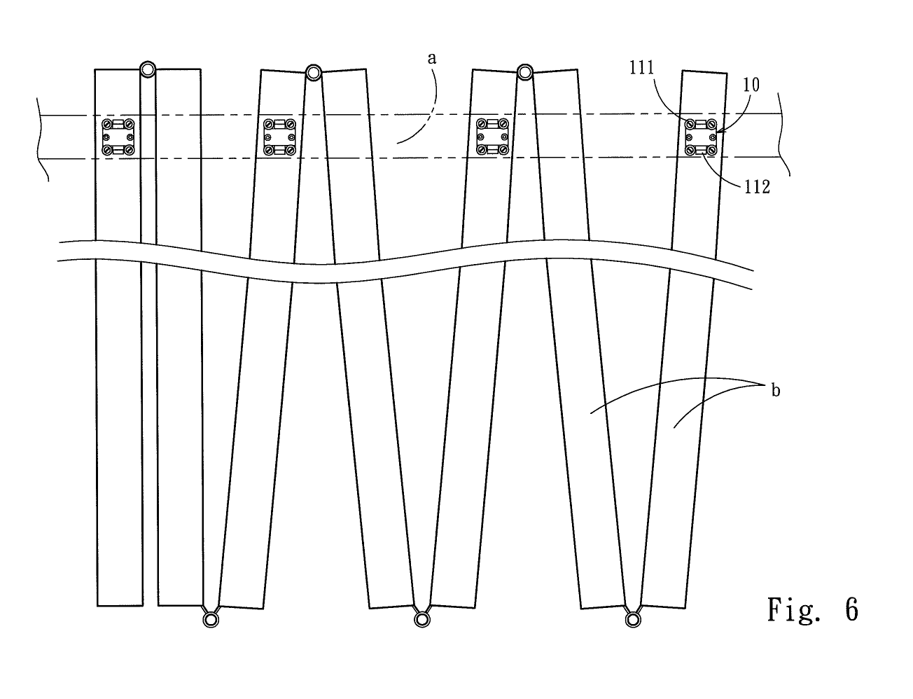

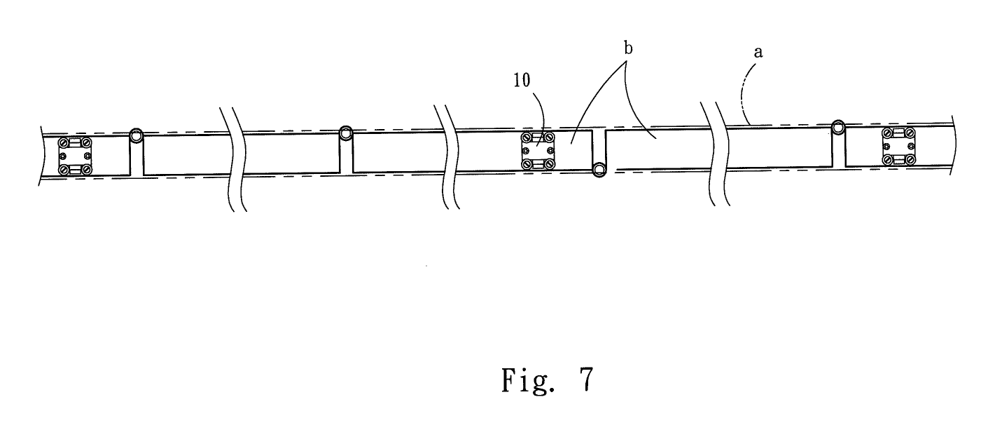

As shown in FIG. 5, the pulley structure of the present invention is mounted on the top of a door leaf b and deviated aside. Here, plural door leaves b are connected together by at least two hinges, so that when not in use, the door leaves b can be folded together, as shown in FIG. 6. When the door leaves b are used in the store or restaurant, they can be unfolded and stretched out in a straight line, so as to provide a temporary partition, as shown in FIG. 7.

Please refer to FIG. 4. The four wheels 121 of the lower pulley base 12 are divided into two pairs straddled at the right and left sides of the bottom a1 inside the track a and roll, and the vertical rolling wheels 112 respectively mounted at the right and left sides of the upper pulley base 11 roll against the top a3 inside the track a, thus the pulley set 10 can be restricted within the track a in the vertical direction, thereby can prevent the pulley set 10 from swinging and/or tilting during movement.

Moreover, the two pairs of horizontal turning wheels 111 respectively located at the right and left sides of the upper pulley base 11 respectively roll against and restricted by the right and left walls a2 of the track a. As being seen in the top view, the four horizontal turning wheels 111 at the four corners of the upper pulley base 11 are restricted by the right and left walls a2 of the track a, so that the pulley set 10 can be restricted within the track a and roll in the horizontal direction, thereby can prevent from swinging and/or tilting during movement. Therefore, the pulley set 10 of the present invention can be restricted simultaneously by the right and left walls, and the bottom and the top from four directions, so that the swinging and/or tilting of the door leaf b can be completely prohibited when folding/unfolding the door leaf b.

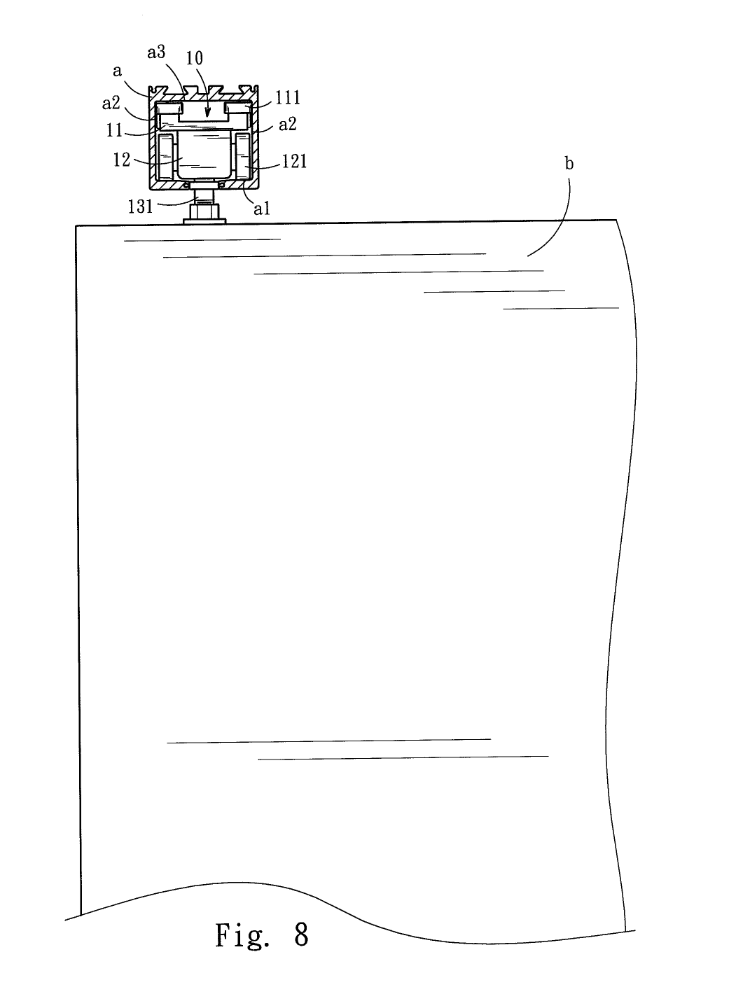

The pulley structure according to the present invention is especially suitable for the situation that the center of gravity of the door leaf b is located at one side of the track a, in which the center of gravity of the folded door leaves b will be located outside the track a, as shown in FIG. 6 and FIG. 8. For preventing the door leaves b from tilting toward one side, after the pulley set 10 is assembled with the track a, the four horizontal turning wheels 111, the two vertical rolling wheels 112 and the four wheels 121 will be restricted in the track a, so that when folding/unfolding the door leaf b, the pulley set 10 can be moved along the track a without swinging and/or tilting. Further, after door leaves b are folded, the problem that the center of gravity of the folded door leaves b is located outside the track a also can be solved, so as to avoid the inconvenience of disposing the channel (not shown in the drawings) under the door leaves 3 in the conventional technique.

Furthermore, owing to the two vertical rolling wheels 112 at the right and left sides of the upper pulley base 11 roll against the top a3 in the track a, and the four wheels 121 of the lower pulley base 12 roll at the right and left sides on the bottom a1 in the track a, the upper and lower portions of the pulley set 10 can be rolled and slid inside the track a smoothly, thereby contributing to the movement upon folding/unfolding the door leaf b. Besides, the bolt 131 which is connected with the lower pulley base 12 through the trust ball bearing 132 is also contributive to save labor during folding/unfolding the door leaf b.

Because the trust ball bearing 132 is installed in the trough 122 and the upper pulley base 11 is covered on the lower pulley base 12, the trust ball bearing 132 can be sealed to avoid dusts and thus prohibit unsmooth operation after long-term use.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A suspended pulley structure for a movable and folding door which is mounted in a track on a ceiling for hanging a door leaf to be moved therein, comprising:
a pulley set including at least four wheels, wherein each two wheels are respectively straddled at the right and left sides of the bottom of the pulley set and roll;
at least four horizontal turning wheels which are divided into a front pair and a rear pair and are vertically hinged at the top of the pulley set in a manner that the two pairs of the horizontal turning wheels respectively roll against right and left walls of the track at a same level;
at least two vertical rolling wheels respectively hinged at the right and left sides of the pulley set in a lateral direction rolling along the top of the track; and
a suspended assembly mounted at the bottom of the pulley set for pivotally hanging the door leaf.

2. The pulley structure as claimed in claim 1, wherein the vertical rolling wheels are mounted between the two pairs of the horizontal turning wheels.

3. The pulley structure as claimed in claim 1, wherein the pulley set comprises an upper pulley base and a lower pulley base locked at the bottom of the upper pulley base, and wherein the four horizontal turning wheels are respectively mounted at four corners of the upper pulley base, the vertical rolling wheels are respectively hinged between the two pairs of the horizontal turning wheels, and the wheels are hinged at the lower pulley base.

4. The pulley structure as claimed in claim 3, wherein the suspended assembly comprises a suspended shaft vertically penetrating through the lower pulley base for hanging the door leaf, and the suspended shaft is connected with the lower pulley base via a trust ball bearing.

5. The pulley structure as claimed in claim 4, wherein the suspended shaft is a bolt including a head portion at one end which has a diameter larger than that of the bolt and the other end of the bolt vertically and downwardly penetrates through the center of the trust ball bearing and the lower pulley base so as to be locked with the door leaf, and wherein the lower pulley base includes a trough vertically formed in the center thereof for receiving the trust ball bearing and the head portion.
